(19) United States
(12) Patent Application Publication
(10) Pub. No.: US 2008/0184237 A1
(43) Pub. Date: Jul. 31, 2008

(54) DATA PROCESSING APPARATUS AND APPLICATION LAUNCHING METHOD

(75) Inventor: Shinichiro IMAMURA, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/774,211

(22) Filed: Jul. 6, 2007

(30) Foreign Application Priority Data
Jan. 25, 2007 (JP) 2007-014858

(51) Int. Cl. G06F 9/445

(52) U.S. Cl. 718/101

(57) ABSTRACT

According to one embodiment, a data processing apparatus comprising: an operating system that manages a correlation between a specific button and a predetermined application allocated for the specific button, and that starts the predetermined application when the specific button is depressed; a storage area that stores data with respect to the correlation; a registry area that is provided separately from the storage area; a first application that is to be started by the operating system when the specific button is depressed; and, a setup application that sets the registry area, wherein the first application reads data correlated with the specific button in the registry area after the registry area is set by the setup application, wherein the first application starts a second application when the data includes an instruction to launch the second application.

### CROSS-REFERENCE TO RELATED APPLICATIONS

This application is based upon and claims the benefit of priority from Japanese Patent Application No. P2007-014858, filed Jan. 25, 2007, the entire contents of which are incorporated herein by reference.

### BACKGROUND

1. Field

The present invention relates to a method for depressing a specific button, provided for a data processing apparatus, for starting an application designated for the specific button, and relates particularly to a method for setting up data consonant with a specific button and for employing the data.

2. Description of the Related Art

To start an application to be operated on a PC (Personal Computer), not only is a method provided for clicking on an application icon on a display, but also a mechanism for depressing a specific button and directly starting a predetermined application.

For example, a function called Hotstart is provided for Windows (registered trademark), which is an OS (Operating System) that is widely employed for PCs (see non-patent document “Configuration of Windows HotStart”, Microsoft Corporation, [online], May 17, 2006, [searched on Jan. 11, 2007], Internet <URL:http://www.microsoft.com/japan/whdc/system /platform/firmware/hotstart.mspx>). This function emulates an operation performed when a specific button is depressed following the activation of a PC, although the PC is actually not activated when the button is depressed. When a predetermined application is allocated and is to be launched in response to the depression of the specific button, the application is launched as the PC is activated.

However, such a function, when provided by an OS, can sometimes be inconvenient. For example, assuming that data for allocating a predetermined application to be launched when a specific button is depressed is included as data in the OS, when this allocation data is changed, the PC must be re-activated in order to update related internal data stored in the PC.

Thus, an example method has been proposed, whereby instead of employing a function provided by an OS, a unique mechanism is employed to switch display screens (see patent document JP-A-2004-227363).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example data processing apparatus according to one embodiment of the present invention.

FIG. 2 is an exemplary block diagram showing the arrangement of the data processing apparatus according to the embodiment.

FIG. 3 is an exemplary diagram showing an example conventional application structure.

FIG. 4 is an exemplary flowchart showing an example conventional process for changing a hardware button setup.

FIG. 5 is an exemplary flowchart showing an example conventional process performed when a hardware button is depressed.

FIG. 6 is an exemplary diagram showing an example application structure for the data processing apparatus of the embodiment.

FIG. 7 is an exemplary flowchart showing an example process performed by the data processing apparatus of this embodiment for a preliminary arrangement for a hardware button setup.

FIG. 8 is an exemplary flowchart showing an example process performed by the data processing apparatus of this embodiment to change a hardware button setup.

FIG. 9 is an exemplary flowchart showing an example process performed by the data processing apparatus of this embodiment when a hardware button is depressed.

### DETAILED DESCRIPTION

Various embodiments according to the invention will be described hereinafter with reference to the accompanying drawings. In general, according to one embodiment of the invention, a data processing apparatus includes: a data processing apparatus comprising: an operating system that manages a correlation between a specific button and a predetermined application allocated for the specific button, and that starts the predetermined application when the specific button is depressed; a storage area that stores data with respect to the correlation; a registry area that is provided separately from the storage area; a first application that is to be started by the operating system when the specific button is depressed; and, a setup application that sets the registry area, wherein the first application reads data correlated with the specific button in the registry area after the registry area is set by the setup application, wherein the first application starts a second application when the data includes an instruction to launch the second application. According to another embodiment of the invention, a data processing apparatus includes: a processor; a storage that stores an operating system, a first program, and a second program; and an input device, wherein the storage stores: a first file managed by the operating system, a second file managed by a first application stored in the storage, and a configuration program that rewrites the second file, wherein the processor executes the first program based on the first file when the input device is input; wherein the processor reads the second file by executing the first program; and wherein the processor executes the second program when a read content read by the processor instructs to execute the second application.

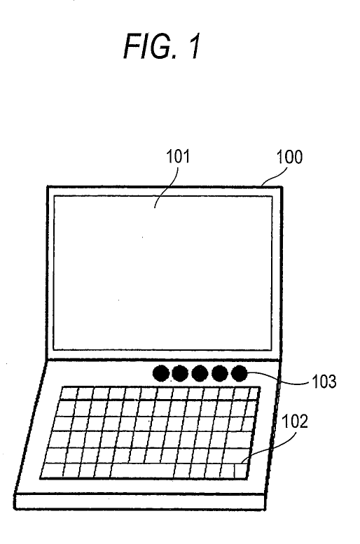

FIG. 1 is a diagram showing an example data processing apparatus according to one embodiment of the present invention. A PC 100, a display unit 101, a keyboard 101 and hardware buttons 103 are shown in FIG. 1.

The PC 100 is a notebook PC into which functions required for data processing are loaded.

The display unit 101 is a display device, such as an LCD (Liquid Crystal Display) device, and is employed to display, on a screen, processing results obtained by the PC 100.

The keyboard 102 is mounted on the surface of the PC 100, and the keys on the keyboard 102 are employed by a user to enter data into the PC 100. Mainly, data is input as a character string, one character for one key, and there is a previously established correspondence between a character that is entered and a key on the keyboard 102. Usually, character keys are not employed for other purposes.

The hardware buttons 103 are one or more buttons mounted on the PC 100, in addition to the keyboard 102. The hardware buttons 103 serve not only as input devices, much as do the keys on the keyboard 102, for entering predetermined data, but also for initiating the performance of specific functions, such as the launching of predetermined applications. Further, a hardware button setup tool is provided that enables a user to freely change the functions designated for the hardware buttons 103.

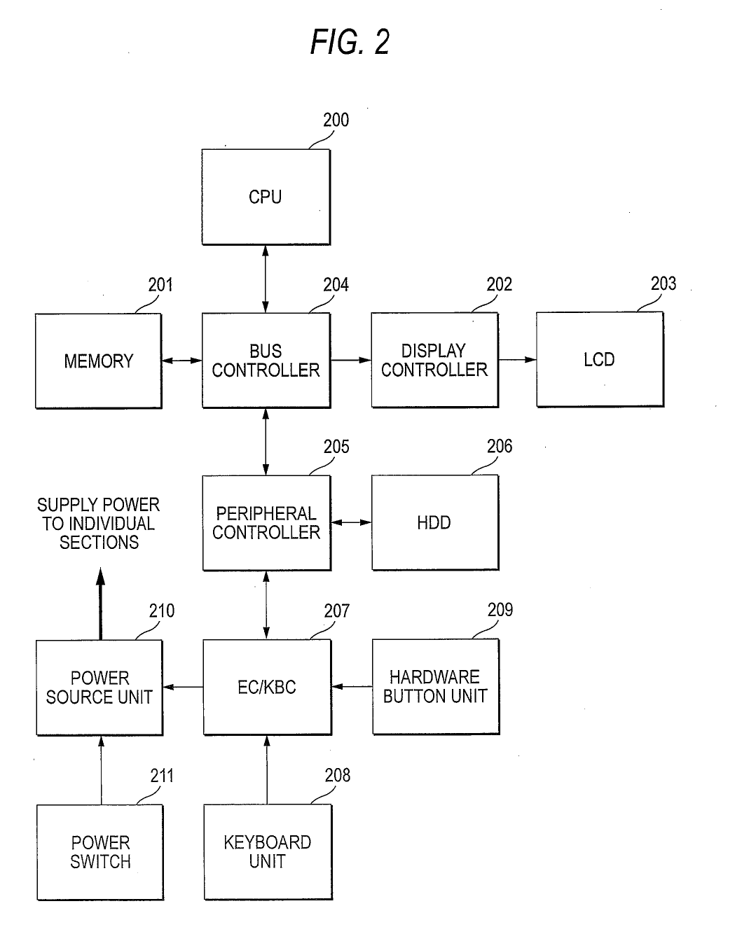

FIG. 2 is a block diagram showing an example configuration for the data processing apparatus according to this embodiment. A CPU 200, a memory 201, a display controller 202, an LCD 203, a bus controller 204, a periphery controller 205, an HDD 206, an EC/KBC 207, a keyboard unit 208, a hardware button unit 209, a power source unit 210 and a power switch 211 are shown in FIG. 2.

The CPU 200 has as functions the execution of code provided as a program and the overall control of the individual functions of the PC 100.

The memory 201 is, for example, a semiconductor memory, and is employed as a temporary storage area for data and for the program code executed by the CPU 200.

The display controller 202 has as functions the processing of desired data, for display on the display unit 101, and the control of the LCD 203.

The bus controller 204 has as functions the management of the exchange of data by individual sections of the PC 100 and the control of a bus that connects these sections.

The peripheral controller 205 has as a function the management of the exchange of data, mainly between the CPU 200 and the other devices.

The HDD 206 is a magnetic disk device incorporated in the PC 100, and is used for the storage of the code for the program executed by the CPU 200. Further, space for a registry area, which is a storage area for setup data that the OS refers to at the time of activation or while running, is also allocated on the HDD 206.

The EC/KBC 207 represents an Embedded Controller/Keyboard Controller. The EC/KBC 207 is operated by power that can be continuously received, even when the CPU 200 is halted. The EC/KBC 207 has as functions the continuous monitoring of the input of data to the PC 100 and, when a predetermined input condition has been established, the performance of a predesignated operation. In this embodiment, the EC/KBC 207 also has, as an additional function, the control of the power supply of the PC 100, and can issue an instruction either for a recovery from a paper feeding state or for the initiation of the activation process for the PC 100.

The hardware button unit 209 includes one or more hardware buttons 103, and has as a function, following the depression of a button, the transmission to the EC/KBC 207 of a notification identifying the hardware button 103 that was depressed.

The power source unit 210 supplies power to the individual sections of the PC 100. While the EC/KBC 207, which is also employed for the supply of power, either controls or halts the supply.

The power switch 211 is manipulated by a user to power on or off the power source unit 210.

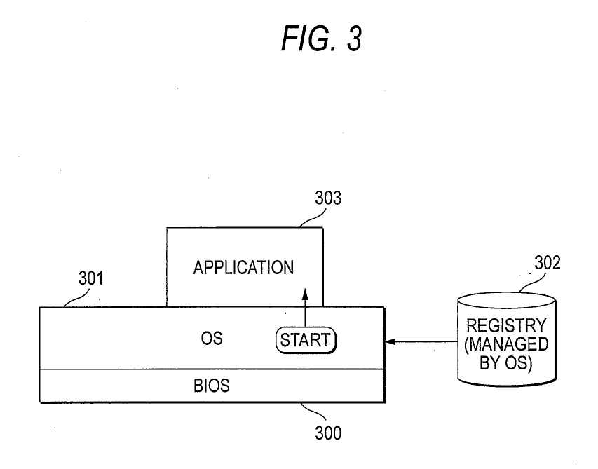

FIG. 3 is a diagram showing an example structure employed for a conventional application.

A program operated by the PC 100 has a hierarchical structure, consisting, for example, of a BIOS 300, an OS 301 and an application 303. At this time, for the BIOS 300, program code for the initial start process and the basic input/output process of the PC 100 are loaded in the ROM (Read Only Memory).

The OS 301 is stored on the HDD 206, and is started by the BIOS 300. The OS 301 provides a UI (User Interface) for a user, and has as one function the management of the execution of an application by the PC 100.

The application 303 is also a program, stored on the HDD 206, that is started either in accordance with a user's instruction or at a time determined by an OS.

In order to start a predetermined application through the depression of a hardware button 103, the BIOS 300 and the OS 301 recognize a hardware button 103 in the hardware button unit 209 was depressed. The OS 301 obtains, from the BIOS 300, data indicating which hardware button 103 was depressed, reads data for a corresponding application from the registry 302, which is managed by the OS 301, and starts the pertinent application.

When a predetermined application is to be started in this manner using a specific hardware button 103, data for the application must be set up in advance in the registry 302, which is managed by the OS 301.

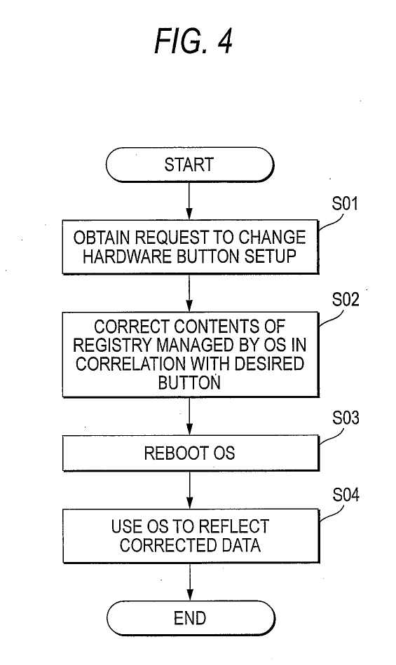

FIG. 4 is a flowchart showing an example conventional process for changing the setup for a hardware button 103.

First, the OS 301 receives a request from a user to change a hardware button 103 setup (step S01).

The OS 301 obtains, from the change request, data indicating the hardware button 103 for which the setup should be changed and data indicating a corresponding application to be started, and changes the pertinent contents of the registry 302 (step S02).

Sequentially, an instruction for the restarting of the OS 301 is automatically relayed to the PC 100 or is entered by the user (step S03).

During the restart process, the OS 301 obtains hardware button setup data from the registry 302, so that the internal data held by the OS 301 reflects the setup data (step S04).

Through this processing sequence, a predetermined application to be started upon the depression of a specific hardware button 103 can be changed.

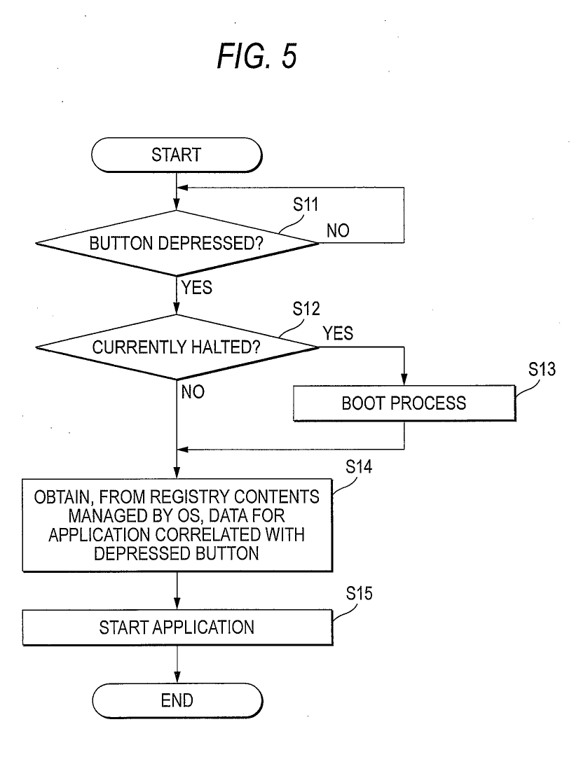

FIG. 5 is a flowchart showing an example conventional process performed after a hardware button 103 has been depressed.

The BIOS 300 determines whether a hardware button 103 has been depressed (step S11). When a hardware button 103 has been depressed (Yes), the BIOS 300 determines whether the PC 100 is currently halted (step S12). When the PC 100 is currently halted (Yes), a booting process for the PC 100 is started (step S13).

The OS 301 obtains from the BIOS 300 data indicating the hardware button 103 that was depressed, reads data for a corresponding application from the registry 302, managed by the OS 301 (step S14), and starts the pertinent application (S15).

In the conventional case, the data for an application to be started upon the depression of the hardware button 103 is stored in the registry 302, managed by the OS 301, and also held as internal data by the OS 301. Therefore, since a user performs a re-setup of the OS 301 each time data for an application is changed, the user must temporarily stop a current job and again activate the PC 100. Usually, it takes time to reboot the PC 100, and during this period, the user can not employ the PC 100.

Further, only data for an application to be started can be set up in the registry 302, and the starting of an application is limited to only an operation performed upon the depression of a hardware button 103. In this case, this hardware button 103 becomes substantially useless after the application is started, and for a data processing apparatus, such as a notebook PC, for which compactness and a light weight are required, not only is the cost is increased, but also the efficiency with which space is utilized is deteriorated.

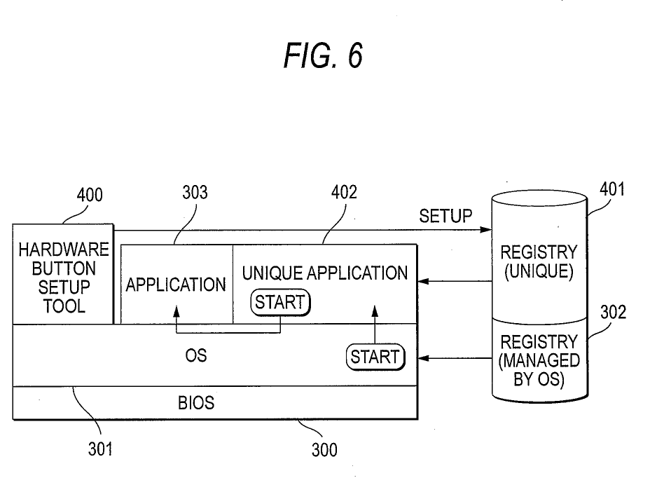

FIG. 6 is a diagram showing an example application structure for the data processing apparatus according to this embodiment. In FIG. 6, a hardware button setup tool 400, a uniquely managed registry 401 and a unique application 402 are shown, in addition to the structure shown in FIG. 3.

The hardware button setup tool 400 is an application for changing the contents of the uniquely managed registry 401, and is operated by the OS 301. Operation of this tool is started only when a user desires to change the contents of the registry 401, and thus, usually need not be activated.

The registry 401 is a registry area that is uniquely prepared in this embodiment, separate from the registry 302 managed by the OS 301. The contents of the registry 401 can be changed by the hardware button setup tool 400, and so long as the tool 400 is employed, the contents of the registry 400 can be freely changed, without any limitation being imposed by the OS 301. In this embodiment, the registry 401 is provided in a registry area that is defined as a resource by the OS 301; however, the registry 401 may instead be recorded as data on a recording device, such as the HDD 206.

The unique application 402 is an application stored on the HDD 206, and is started by the OS 301. The unique application 402, when started, refers to the registry 401, and as needed, starts the application 303. An application the unique application 402 starts, or a process the unique application 402 performs is designated in advance for the registry 401 by the hardware button setup tool 400.

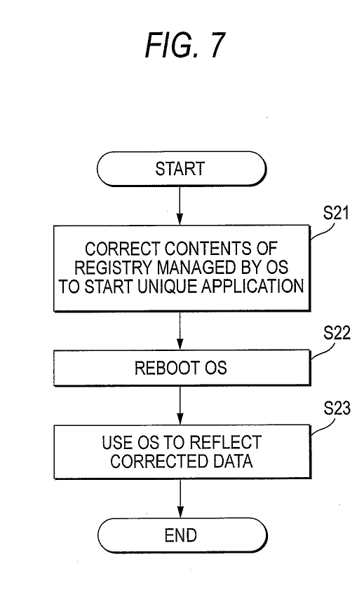

FIG. 7 is a flowchart showing an example process performed by the data processing apparatus of this embodiment for a preliminary arrangement of the hardware button setup. In this embodiment, in order to utilize the hardware button functions of the OS 301, the OS 301 is so prepared that a predetermined application is started when a specific button is depressed.

First, the function of the OS 301 is employed to correct the contents of the registry 302, so that the unique application 402 is started when a specific hardware button 103 is depressed (step S21).

Sequentially, the OS 301 is rebooted (step S22), so that the operation of the hardware button 103 identified by the OS 301 reflects the contents of the registry 302 (step S23).

Through this setup, the unique application 402 is started by depressing a specific hardware button 103.

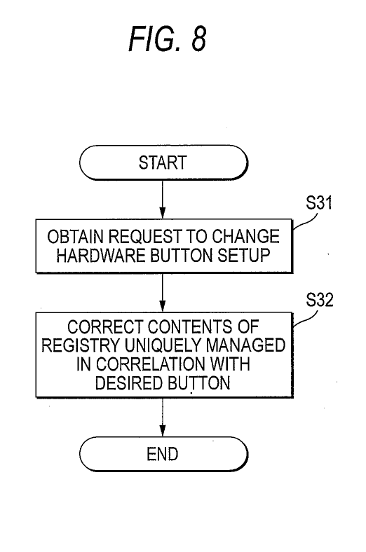

FIG. 8 is a flowchart showing an example process performed by the data processing apparatus of this embodiment to change the hardware button setup.

The hardware button setup tool 400 is started, and obtains, via the UI (User Interface) displayed by an application, data as to how a user desires to change the hardware button setup (step S31). The data for changing the setup can be entered using the keyboard 102 while viewing the display unit 101. Further, the data may be transmitted from a remote area via a network, or may be entered vocally by employing a PC 100 having a voice recognition function.

Upon receiving the change data, the hardware button setup tool 400 changes the contents of the registry 401 in accordance with the data (step S32). Regardless of whether the OS 301 recognizes that the contents in the registry 401 have been updated, the updated contents can be immediately read by an application that is designed to read data from the registry 401.

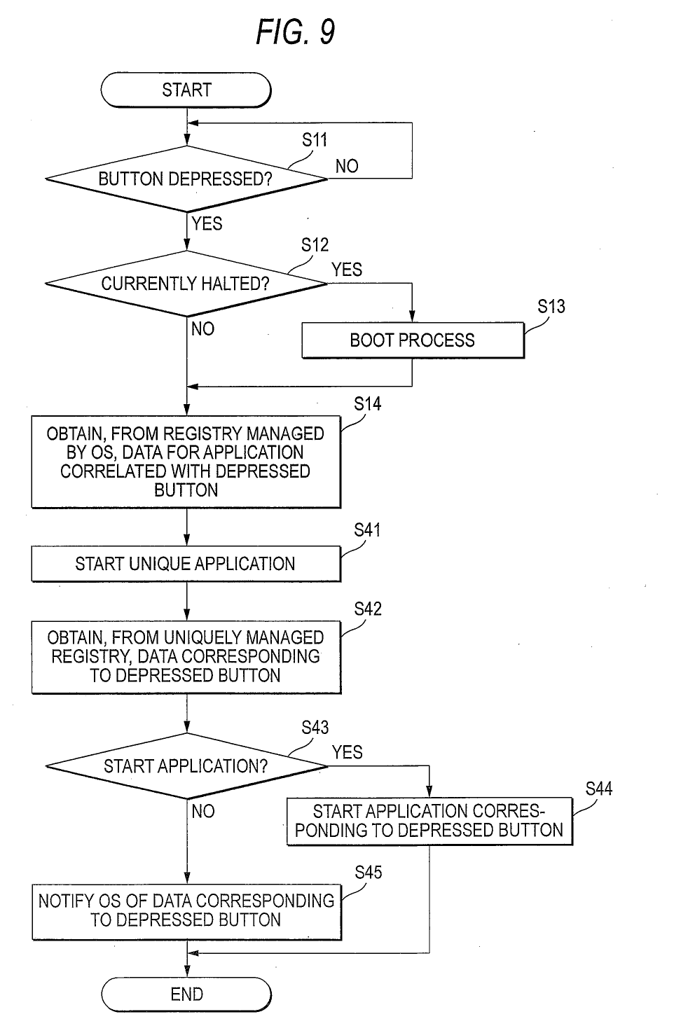

FIG. 9 is a flowchart showing an example process performed by the data processing apparatus of this embodiment when a hardware button 103 is depressed.

For this process, since a function of the OS 301 is employed up to step S14, the same process sequence is performed as was explained while referring to the flowchart for the conventional process performed when a hardware button 103 was depressed.

For this embodiment, at step S15, the unique application 402 designated by the OS 301 for the preliminary arrangement is started (step S41).

The unique application 402 thus started obtains, from the BIOS 300, data about the depressed hardware button 103, and receives from the uniquely managed registry 401 data that is correlated with the hardware button 103 (step S42).

Following this, the unique application 402 determines whether the obtained data is for an instruction for starting a predetermined application (step S43). When the data is for an instruction for starting the application (Yes), the application indicated by the data is started (step S44).

When the data does not indicate an instruction for starting an application (No), data obtained from the registry 401, in correlation with the hardware button 103, is transmitted to the OS 301 (step S45).

With this arrangement, when a hardware button is depressed, not only is a predetermined application started, but also a predetermined message or key data can be transmitted to the OS 301, or to another application run by the OS 301. For example, when a specific hardware button 103 is depressed, a video playing application is started, and further, for that video play application, which is then operating, a play/stop/fast forward instruction can be issued using the same button.

Therefore, an allocated application change can be flexibly performed for the launching of an application using a specific button provided by the OS 301, and the specific button can be employed for a purpose other than the launching of the application.

The present invention is not limited to the embodiment, and to carry out the present invention, the components of the embodiment can be variously modified without departing from the subject of the invention. Further, various inventions can be provided by appropriate combinations of multiple components disclosed in the embodiment. For example, several components illustrated in the embodiment may be eliminated, or components extracted from a different embodiment may be employed appropriately.

As described with reference to the embodiment, there is provided a data processing apparatus that the allocation of an application to be launched may be flexibly changed by using a specific button provided by an OS, and the specific button may be employed for a purpose other than the launching of an application. Further, there is provided an application launching method that the allocation of an application to be launched may be flexibly changed by using a specific button provided by an OS, and the specific button may be employed for a purpose other than the launching of an application.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data processing apparatus comprising:
an operating system that manages a correlation between a specific button and a predetermined application allocated for the specific button, and that starts the predetermined application when the specific button is depressed;
a storage area that stores data with respect to the correlation;
a registry area that is provided separately from the storage area;
a first application that is to be started by the operating system when the specific button is depressed; and, a setup application that sets the registry area,
wherein the first application reads data correlated with the specific button in the registry area after the registry area is set by the setup application,
wherein the first application starts a second application when the data includes an instruction to launch the second application.

2. The data processing apparatus according to claim 1, wherein, when the data read from the registry area instructs to pass a predetermined value corresponding to the specific button, the first application transmits the predetermined value to the operating system.

3. An application launching method for a data processing apparatus, wherein the data processing apparatus includes an operating system that manages a correlation between a specific button and a predetermined application, the predetermined application to be started when the specific button is depressed, the data processing apparatus includes a first registry area that stores first data with respect to the correlation, a second registry area that is separable from the first registry area, and a setup application that sets the second registry area, the method comprising:
setting up a first application as the predetermined application, the first application configured to read data in the second registry area;
allocating second data in the second registry area by using the setup application, the second data corresponding to information of a second application that is to be started when the specific button is depressed in substitution for the predetermined application;
starting the first application by depressing the specific button; and
reading the second data from the second registry area by using the first application to launch the second application.

4. An application launching method according to claim 3,
wherein, when the second data includes an instruction to pass a predetermined value corresponding to the specific button, the predetermined value is transmitted to the operating system.

5. A data processing apparatus comprising:
a processor;
a storage that stores an operating system, a first program, and a second program; and
an input device,
wherein the storage stores:
a first file managed by the operating system,
a second file managed by a first application stored in the storage, and
a configuration program that rewrites the second file,
wherein the processor executes the first program based on the first file when the input device is input;
wherein the processor reads the second file by executing the first program; and
wherein the processor executes the second program when a read content read by the processor instructs to execute the second application.

6. The data processing apparatus according to claim 5, wherein, when the read content instructs to pass a predetermined value corresponding to the input device to the operating system, the processor pass the predetermined value to the operating system.

7. The data processing apparatus according to claim 5, wherein each of the first file and the second file includes a registry file.

8. The data processing apparatus according to claim 5, wherein the first program refers the second file rewritten by the configuration program.
